(19) United States
(12) Patent Application Publication
(10) Pub. No.: US 2010/0236118 A1
(43) Pub. Date: Sep. 23, 2010

(54) SNAP N PLACE SIGN SYSTEM AND METHOD OF USE FOR INTERIOR SIGNS

(76) Inventors: Roxanna Meyers, Albuquerque, NM (US); Wesley Meyer, San Francisco, CA (US); Leon Smith, Albuquerque, NM (US)

Correspondence Address: ORTIZ & LOPEZ, PLLC, P.O. BOX 4484, ALBUQUERQUE, NM, 87196-4484, US

(21) Appl. No.: 12/691,570

(22) Filed: Jan. 21, 2010

Related U.S. Application Data
(60) Provisional application No. 61/146,267, filed on Jan. 21, 2009.

(51) Int. Cl. G09F 7/02

(52) U.S. Cl. 40/611.01

(57) ABSTRACT

A Snap N Place sign system and method for supporting a sign message includes a sign substrate associated with a number of rubber nipple fasteners and a lens. The sign message and the lens further include mounting holes placed at their corners for securely holding the sign message in association with the sign substrate and lens. The rubber nipple fastener can be pulled through the mounting holes in the lens utilizing a relatively low insertion force. The rubber nipple fasteners can be driven axially into the mounting holes in the lens with a flexible tab engaging the lens and flexing as they move through the hole in the lens. The rubber nipple fastener can be specifically designed such that the force required to install or push the rubber nipple fastener through the mounting hole is relatively low thereby facilitating ergonomic considerations. The Snap N Place sign system is capable of holding signs of a variety of thicknesses and sizes.

### INVENTION PRIORITY

This invention claims priority as a continuation application of U.S. Provisional patent application Ser. No. 61/146,267, filed Jan. 21, 2009 entitled “flexible sign holding and fastening system”, which is herein incorporated by reference.

### TECHNICAL FIELD

Features are generally related to interior room signs/nameplates and how they are updated or changed in a convenient, timely and low cost manner. Features are also related to fasteners for securing and supporting the sign lens to the substrate of the sign and holding in place a message.

### BACKGROUND OF THE INVENTION

Historically in the interior sign industry, when an end-user needed to change the text or message on a room sign or nameplate, a new room sign/nameplate would need to be manufactured. Over the years, room signs and nameplate products have been developed that allowed the end-user to take the lens off a room sign/nameplate and change the message of the sign, however the removal of the lens required an additional “tool” such as a suction cup or “key” in order to remove the lens. Experience has proven that the “tool” or key” is typically lost or misplaced.

Based on the foregoing, it is believed that a need exists for an improved inherent fastener and system that allows the end-user to make changes to a sign message in a timelier and cost efficient manner, as will be described in greater detail herein. For these reasons the present inventor(s) provide a snap in place sign system (hereinafter referred to for convenience as “Snap N Place sign system”) that has a fastener embedded in the sign substrate and therefore cannot get misplaced. The Snap N Place sign system can use different kinds of substrates (i.e., plastic or aluminum) and can be provided in a variety of sizes (i.e., room or cubical signs, nameplates, suite or conference room signs).

### BRIEF SUMMARY

The following summary is provided to facilitate an understanding of some of the innovative features unique to the Snap N Place sign system and is not intended to be a full description. A full appreciation of the various aspects of the Snap N Place sign system as disclosed herein can be gained by taking the entire specification, claims, drawings, and abstract as a whole.

It is, therefore, one aspect of the disclosed features to provide for an imbedded fastener that will hold a sign lens to the substrate of the sign and allow for a message to be sandwiched in between the substrate and the lens.

It is another aspect of the disclosed features to provide for a timely and cost effective way in which to remove the sign lens in order to update the sign message.

The aforementioned aspects and other objectives and advantages can now be achieved as described herein. In accordance with features of the invention, the sign will include a sign substrate, the imbedded rubber nipple fastener and a sign lens. The sign substrate has calibrated counter-sunk holes drilled to allow the rubber nipple fasteners to lock in place by virtue of the size of the hole and pulling the rubber nipple fastener through each of the calibrated holes. The sign lens includes calibrated holes placed at the corners for securely holding the lens to the substrate via the rubber nipple fastener—this allows the lens to stay securely on but also allows for easy removal when desired.

To remove the sign lens, grip the middle of the lens on both sides with an index finger. Pull up gently. As the lens starts to flex, slide fingers to one edge of the plate and pull up slightly when you get to the rubber nipple fasteners. The lens will free itself from the rubber nipple fastener and the substrate of the sign. Repeat on the other side of the sign to remove the entire lens.

The sign message can be changed by printing on a transparency (found at any office supply store) and replaced by the end-user. Once the new message (with corresponding holes punched in the transparency) is in place, the lens can be put back in place by aligning the four holes in the lens with the four rubber nipple fasteners and pinching one of the rubber nipple fasteners and pulling up until the fastener stretches slightly. While the fastener is still stretched, push down on the edge of the lens and snap it down into position, thereby sandwiching the message in between the substrate and the lens.

It is another feature of the present invention that a size of the sign substrate and lens can vary to accommodate a different messages and needs (i.e. room signs, cubicle signs, or suite and conference room signs).

It is yet another feature of the present invention that the Snap N Place sign system allows a sign to be ADA compliant (Title Ill Regulations, 28 CFR, Ch. 1, Pt. 36, App. A, 4.30, revised Aug. 1, 1994).

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the disclosed features.

FIG. 1 illustrates a perspective view of a Snap N Place sign system, in accordance with the disclosed features;

FIG. 2.A pictorially illustrates the lens being removed from the sign substrate;

FIG. 2.B pictorially illustrates the sign message being removed from the sign substrate;

FIG. 2.C pictorially illustrates the back of the sign substrate, detailing the calibrated counter sunk area and hole drilled to allow the rubber nipple fastener to lock in place;

FIG. 3 illustrates an exploded perspective view and details the various components of the Snap N Place sign system, in accordance with the disclosed features;

FIG. 4 illustrates a view of the lens used in the Snap N Place sign system, in accordance with the disclosed features;

FIG. 5 illustrates the back of the sign substrate, detailing the calibrated counter sunk area and hole drilled to allow the rubber nipple fastener to lock in place;

FIG. 6 illustrates a sectional side view of the Snap N Place sign system associated with the rubber nipple fastener, in accordance with features of the present invention;

FIG. 7 illustrates an elevated view of the complete Snap N Place sign system;

FIG. 8 illustrates how to change the message in a Snap N Place sign system, detailing steps to remove the lens, replace the sign message and place the lens back on the substrate, in accordance with the disclosed features.

### DETAILED DESCRIPTION

The particular values and configurations discussed in these non-limiting examples can be varied and are cited merely to illustrate at least one embodiment and are not intended to limit the scope thereof.

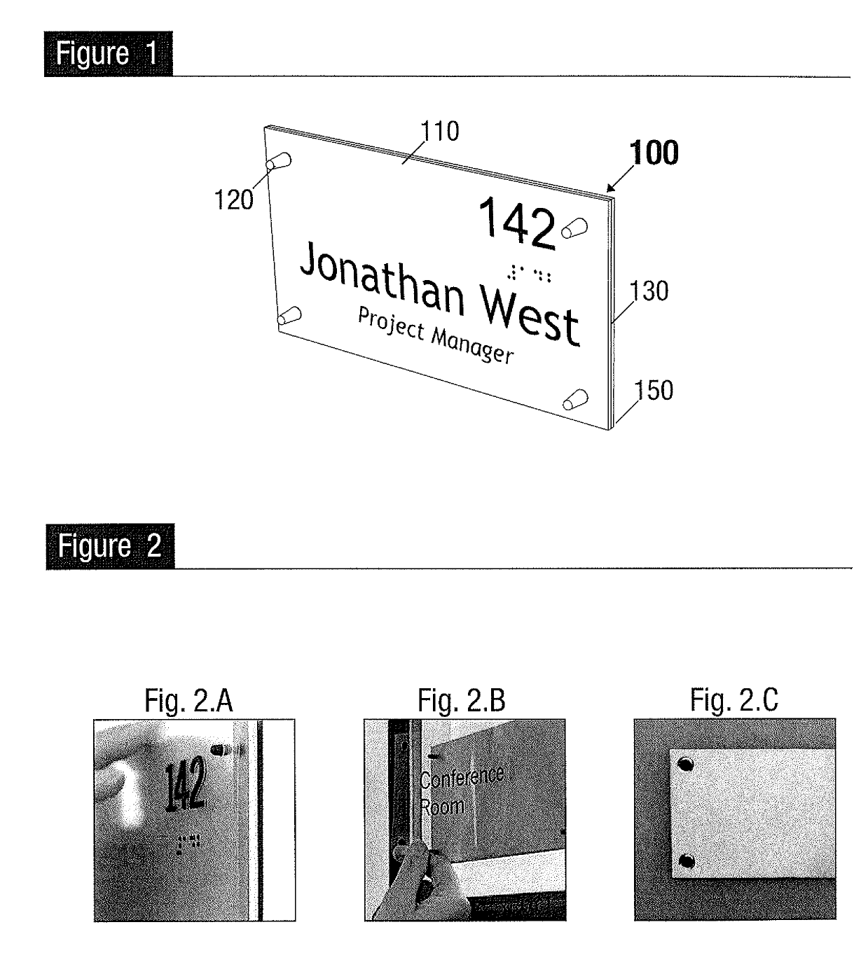

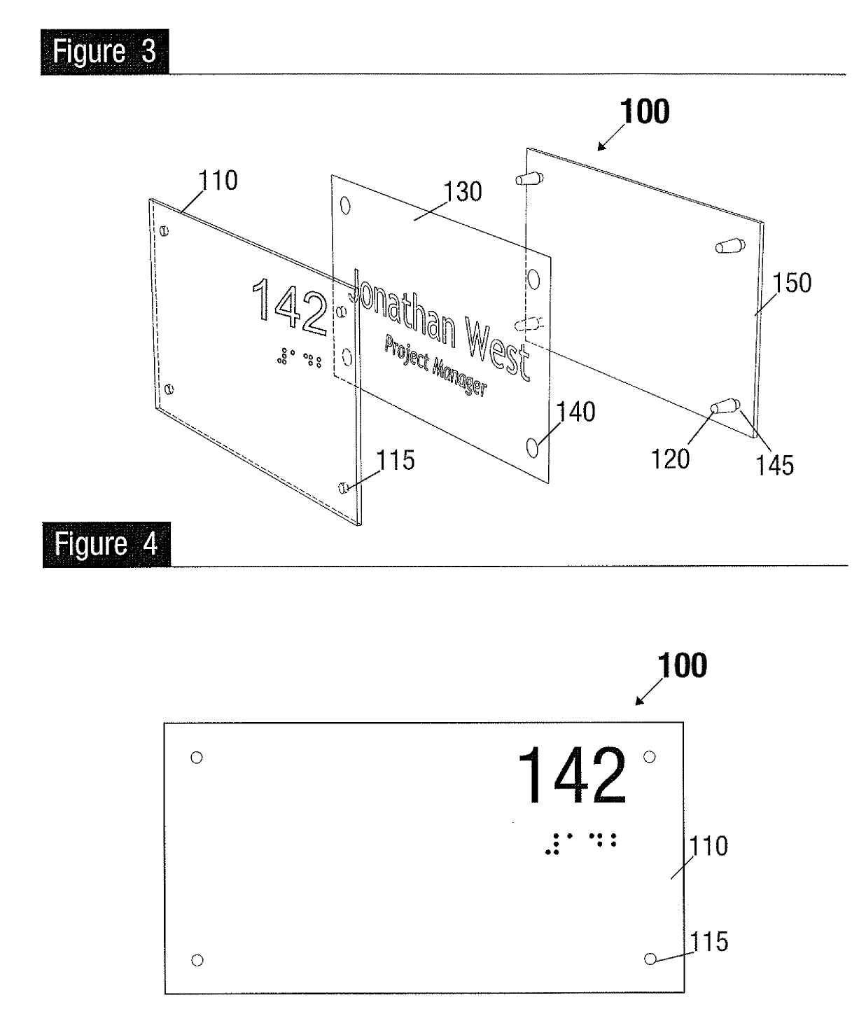

FIG. 1 illustrates a perspective view of a Snap N Place sign system 100, in accordance with the features. Note that in FIGS. 1-8, identical or similar blocks are generally indicated by identical reference numerals. The Snap N Place sign system 100 is simple and inexpensive to manufacture and requires little or no skill to change a sign message. The Snap N Place sign system 100 generally includes a sign substrate 150, a lens 110 and a number of rubber nipple fasteners 120 for securely holding a sign message 130 in between the sign substrate 150 and the lens 110. The lens 110 is preferably constructed of a clear pliable, durable engraving plastic such that the content of the sign message 130 is protected from physical damage. The Snap N Place sign system 100 can be made capable of holding various sign messages and the sign substrate 150 and lens 110 can be made in a variety of thicknesses and sizes.

FIG. 3 illustrates an exploded perspective view of the Snap N Place sign system 100, in accordance with the disclosed features. The Snap N Place sign system 100 further includes a sign substrate 150 associated with the rubber nipple fasteners 120, a sign message 130 and the lens 110. The sign message 130 can be typically made of clear transparency material but could also be made of paper, cardboard, or poster board. However, it should be appreciated that other materials or laminates thereof can also be utilized. The sign message 130 and the lens 110 include a number of mounting holes 140 and 115 placed at four corners for securely holding the sign message 130 in association with the sign substrate 150 utilizing the rubber nipple fastener 120. The rubber nipple fastener 120 can be pulled through the holes 115 in the lens 110 utilizing a relatively low insertion force. Although “rubber” is used herein to identify the rubber nipple fastener 120 described herein, it should be appreciated that the nipple faster can be made from flexible rubber-like material with properties like rubber, depending upon design considerations. Therefore, it should be appreciated that other types of materials may be utilized in place of the suggested material.

The mounting holes 140 on the sign message 130 align substantially with the holes 115 on the lens 110 so that the sign message 130 and the lens 110 may be secured to one another via the holes 140 and 115. Although both lens 110 and the sign substrate 150 are shown as being planar, in other features of the present invention these panels may be substantially concave or convex. The sign message 130 can be positioned between the sign substrate 150 and the lens 110. The sign message 130 may include a wide range of content, including, but not limited to, images, designs, photographs, text, or combinations thereof.

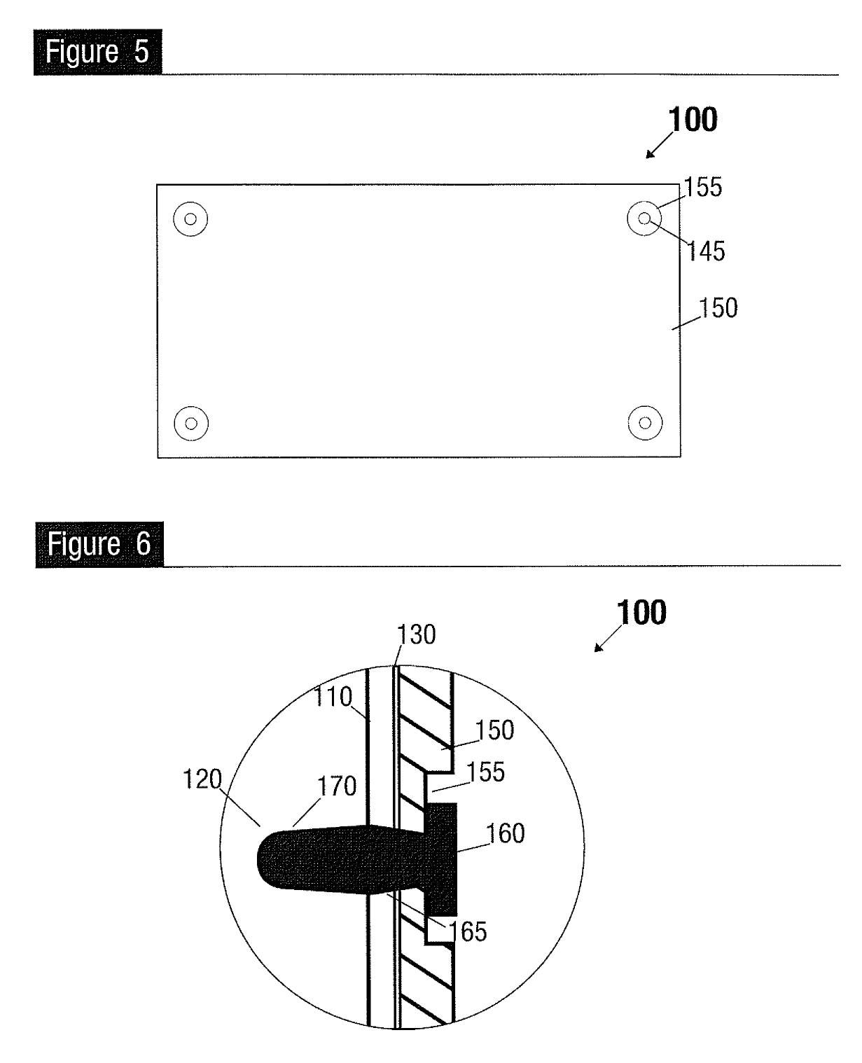

FIG. 4 illustrates a view of the lens used in the Snap N Place sign system 100, in accordance with the disclosed features. The lens hole 115 allows the rubber nipple fastener 120 to be pulled through. The lens 110 can be made of pliable clear engraving plastic.

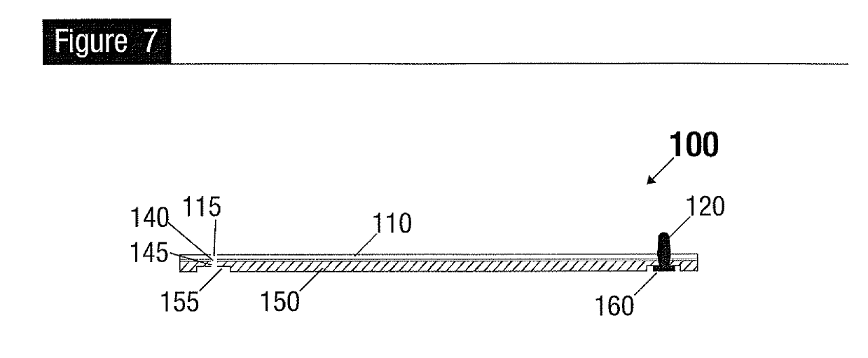

FIG. 5 illustrates the back of the sign substrate 150, detailing the calibrated counter sunk area 155 which allows the rubber nipple fastener 120 to lock in place. The calibrated counter sunk area 155 has a depth that allows the rubber nipple faster enlarged head 160 to sit flush with the back of the sign substrate 150. The calibrated hole 145 drilled in the center of the calibrated counter sunk area 155 allows the rubber nipple fastener 120 to lock in place by virtue of the size of the hole 145.

FIG. 6 illustrates a sectional side view of the Snap N Place sign system 100 associated with the rubber nipple fastener 120 as it fits into the calibrated counter sunk area 155 and through the calibrated hole 145, in accordance with the disclosed features. The rubber nipple fasteners 120 of the present invention are preferably made of rubber depending upon design considerations, although it is conceivable that other materials will provide the flexibility of rubber and provide an equivalent functionality; therefore, rubber should be interpreted broadly to include such materials. It can be appreciated, however, that such features can be implemented in the context of other rubber nipple fasteners. The rubber nipple fastener 120 has features that include an enlarged head 160, an elongated tapered shank 165 and a flexible tab 170. The elongated tapered shank 165 of the rubber nipple fastener 120 associated with the sign substrate 150 fits tightly into the lens 110. Accordingly, the flexible tab 170 of the rubber nipple fastener 120 is pulled through the sign substrate hole 145, then through the sign message hole 140 and finally through the lens hole 115 providing a secure and stable means for securing the sign message 130, the lens 110 and the sign substrate 150 together.

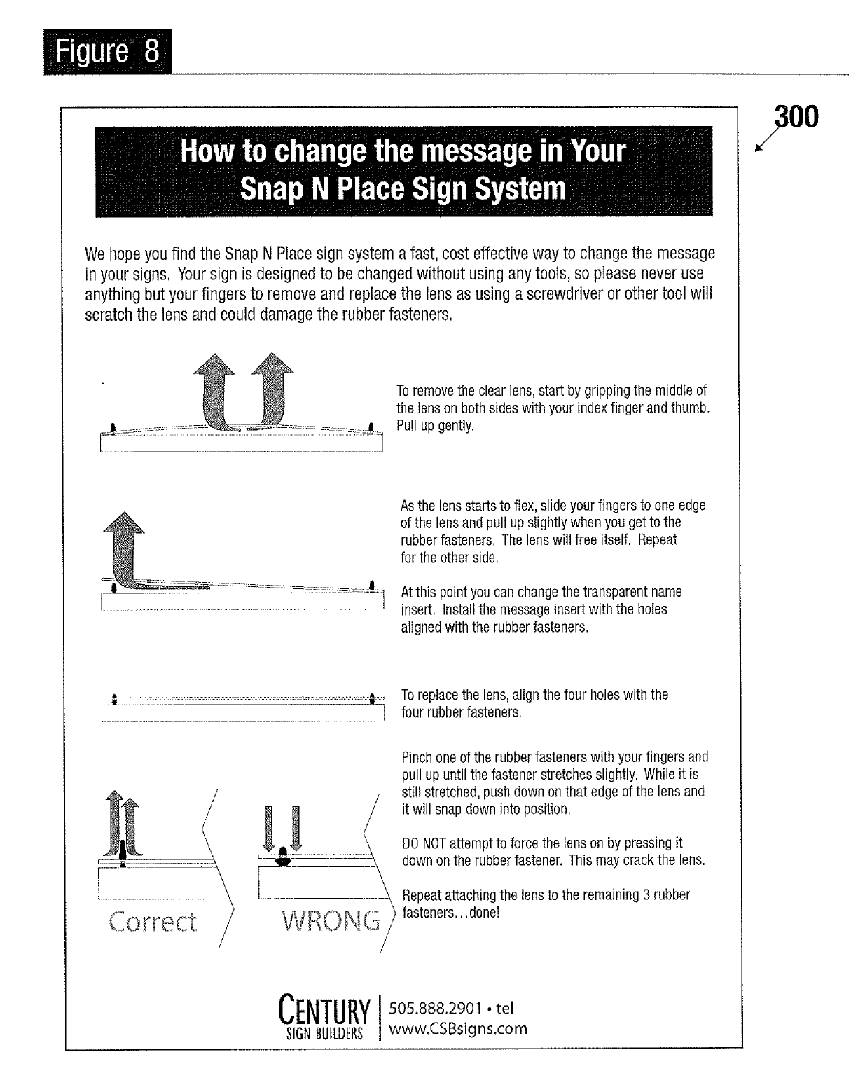

FIG. 7 illustrates an elevated view of the complete Snap N Place sign system and each of its components. The sign message 130 can be placed on top of the sign substrate 150, matching the calibrated holes 145 and 140. Then the lens 110 can be placed on top of the sign message 130, aligning the calibrated holes 145, 140 and 115 together and pulling the rubber nipple fastener 120 through the hole 115, as depicted in FIG. 3.

FIG. 8 illustrates how to change the message in a Snap N Place sign system 300. To remove the sign message 130 (in order to change it), first the lens 110 must be removed by gripping the middle of the lens 110 on both sides with index figure and thumb. As the lens 110 starts to flex, slide finger to one edge of the lens 110 and pull up slightly when at the rubber nipple fastener 120. The lens 110 will free itself from the rubber nipple fastener 120, then repeat for any other rubber nipple fastener 120 locations. Remove current sign message 130 and replace with new sign message 130, aligning holes 140 to rubber nipple fastener 120 locations. Place lens 110 and align holes 115 to the rubber nipple fastener 120 locations. Pinch one of the rubber nipple fasteners 120 up until it stretches slightly. While the rubber nipple fastener 120 can be still stretched, push down on that edge of the lens 110, snapping the lens 110 into position. Repeat the same action to attach the lens 110 to any remaining rubble nipple fasteners 120, as illustrated in FIG. 7.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A Snap N Place sign system, comprising a sign substrate including at least one rubber nipple fastener protruding from a surface of said sign substrate, said at least one rubber nipple further comprising an enlarged head and a shank disposed between the enlarged head and the surface of said sign substrate, wherein said at least one rubber nipple fastener accepts a replaceable sign message having at least one mounting hole formed therein for securely holding said sign message against the surface of said sign substrate at said shank and wherein said at least one rubber nipple also accepts a lens having at least one mounting hole formed therein for securely holding said lens against said sign message and the surface of said sign substrate at said shank.

2. The Snap N Place sign system of claim 1, wherein said lens is transparent.

3. The Snap N Place sign system of claim 1, wherein said lens is ADA compliant.

4. The Snap N Place sign system of claim 2, wherein said lens is ADA compliant.

5. The Snap N Place sign system of claim 3, wherein said lens is transparent.

6. The Snap N Place sign system of claim 1, wherein said at least one rubber nipple fastener is pulled through said at least one mounting hole associated with said sign message and said lens utilizing a low insertion force such that said lens and said sign substrate are securely held together holding the replaceable sign message there between.

7. A Snap N Place sign system, comprising:
a sign substrate associated with at least one rubber nipple fastener;
a replaceable sign message including front and back surfaces, said sign message having at least one mounting hole formed in said sign message for securely holding the back surface of said sign message against said sign substrate with an entire back surface contacting said sign substrate; and
a lens including front and back surfaces, said lens having at least one mounting hole formed in said sign lens for securely holding the back surface of said lens against the front surface of said sign message

8. The Snap N Place sign system of claim 7, wherein said sign message is changed by gripping center of said lens on both edges and pulling said lens in order to release said lens for the at least one rubber nipple fastener.

9. The Snap N Place sign system of claim 7, wherein said lens is transparent.

10. The Snap N Place sign system of claim 7, wherein said lens ADA compliant.

11. The Snap N Place sign system of claim 9, wherein said lens is ADA compliant.

12. The Snap N Place sign system of claim 10, wherein said lens is transparent.

13. A method for using a Snap N Place sign system, comprising:
providing a sign substrate including at least one rubber nipple fastener protruding from a surface of said sign substrate, said at least one rubber nipple further comprising an enlarged head and a shank disposed between the enlarged head and the surface of said sign substrate;
placing a replaceable sign message having at least one mounting hole formed therein over the surface of said substrate and pulling said rubber nipple fastener through said at least one mounting hole formed in said replaceable sign message; and
place a lens having at least one mounting hole formed therein over said replaceable sign message and pulling said rubber nipple fastener through said at least one mounting hole formed in said lens.

14. The method for using a Snap N Place sign system of claim 13, wherein said at least one mounting hole permit reliable holding and ease in removing said lens from said at least one rubber nipple fastener.

15. The method for using a Snap N Place sign system of claim 13, wherein said sign message is changed by gripping center of said lens on both edges and pulling said lens in order to release said lens for the at least one rubber nipple fastener.

16. The method for using a Snap N Place sign system of claim 13, wherein said lens is transparent.

17. The method for using a Snap N Place sign system of claim 13, wherein said lens ADA compliant.

18. The method for using a Snap N Place sign system of claim 16, wherein said lens ADA compliant.

19. The method for using a Snap N Place sign system of claim 17, wherein said lens is transparent.
